(19) United States
(12) Patent Application Publication
(10) Pub. No.: US 2007/0124804 A1
(43) Pub. Date: May 31, 2007

(54) System and method to provide for passive anti-theft dockable devices

(75) Inventors: Robert J. Burnham, Novi, MI (US); George J. DeHelian JR., Roseville, MI (US); Raul L. Selgado, Canton, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/287,830

(22) Filed: Nov. 28, 2005

(51) Int. Cl. H04L 9/32

(52) U.S. Cl. 726/5

(57) ABSTRACT

The system includes a removable entertainment device that interfaces with a docking station. The removable entertainment device includes a controller that implements a software lock to disable the removable entertainment device, if it is improperly removed from the docking station. The docking station uses a challenge and response message to provide a secure methodology to control the unlocking of the removable entertainment device.

### BACKGROUND

1. Field of the Invention

The present invention generally relates to a system and method to provide passive anti-theft protection for a removable entertainment device.

2. Description of Related Art

Media entertainment devices such as DVD players have become readily available as options on many vehicles. In addition, with the increase in technology and advance of electronics manufacturing, the cost and size of portable entertainment devices such as portable DVD players have also become attractive. Accordingly, portable entertainment devices such as DVD players that can dock with vehicles have been designed and implemented. These systems provide the convenience of vehicle systems, such as vehicle integrated controls, vehicle sound system compatibility, and convenient viewing. In addition, the removable entertainment device may be readily removed from the vehicle and used elsewhere. However, the easy removal of the removable entertainment device may often leave such devices vulnerable to theft. Due to the high value and desirability of such players, a high theft rate may present an issue as to the long term viability of such products. In addition, theft may also be an issue for the vehicle manufacturer. Therefore, two theft scenarios must be addressed. First, the portable media device may be taken from a build and assembly plant and/or the dealership prior to vehicle installation or customer delivery. Second, the player may be stolen from the docking station in the vehicle after the consumer has purchased the vehicle. Although various docking mechanisms may be used to defeat removal of the player from the docking station, a more passive approach may be desirable and more convenient for the consumer.

In view of the above, it is apparent that there exists a need for a system and method to provide passive anti-theft protection for a removable entertainment device.

### SUMMARY

In satisfying the above need, as well as overcoming the enumerated drawbacks and other limitations of the related art, the present invention provides a system and method to provide passive anti-theft protection for a removable entertainment device.

The system includes a removable entertainment device that interfaces with a docking station. The removable entertainment device includes a controller that implements a software lock to disable the removable entertainment device, if it is improperly removed from the docking station. The docking station will use a challenge (seed) and response (key) message to provide a secure methodology to control the unlocking of the removable entertainment device.

To address the protection of the removable entertainment device during production and shipment, the removable entertainment device is shipped in the anti-theft locked state of operation. In order for the removable entertainment device to be operated, it must first be docked into a valid docking station. The docking station sends a request for a seed to the removable entertainment device. In turn, the removable entertainment device responds with a seed, which is essentially a random number. Using the removable entertainment device supplied seed, the docking station will generate an algorithm dependent encrypted key. To complete the unlock sequence the docking station will issue an Unlock command, passing the encryption key as a parameter. The removable entertainment device then authenticates the key using the same algorithm and seed used to generate the key by the docking station. After authentication, the removable entertainment device enters an unlocked mode of operation. In the unlocked mode of operation, the removable entertainment device becomes fully functional. Otherwise, each time the removable entertainment device is powered up, it displays a “Player Locked” message for thirty seconds prior to entering its idle state of operation (off mode). It should be noted that both the removable entertainment device and docking station have re-try mechanisms. The re-try mechanisms may be used to ascertain the removable entertainment device mode (locked/unlocked), receive the encryption seed, validate the encrypted seed, and unlock the removable entertainment device. If the re-try mechanism fails, the “Authentication Failed” message is displayed, the docking station enters a shutdown state, and the removable entertainment device enters a display locked state. This is done to supply a degree of robustness, yet disallowing an unlimited number of retries which could ultimately lead to circumvention of the unlock procedure.

To address the protection of the portable media device in the vehicle, each time the vehicle is powered down the docking station issues a lock enable command to the removable entertainment device. As long as the removable entertainment device remains docked, it will provide full user functionality allowing media playback using an internal battery, such as a Li-ion battery. If the removable entertainment device is removed from the docking station while in the lock-enabled state, the removable entertainment device will enter the anti-theft locked mode of operation and will prohibit user operation. As stated above, each time removable entertainment device is powered up, it will display the “Player Locked” message for thirty seconds before entering the shutdown state. To unlock the removable entertainment device and regain full user functionality the user must install the removable entertainment device into a valid docking station and apply full vehicle power to initiate the seed and key unlock procedure described above. The removable entertainment device is intended to be removed only when vehicle power is applied (i.e. the customers keys are in the ignition). Therefore, under normal usage the removable entertainment device would be in its unlocked state while being removed from the docking station. Therefore, under normal usage the removable entertainment device would never be undocked while in the lock enabled state.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a perspective view of a removable entertainment device in accordance with the present invention;

FIG. 2 is a schematic view of a removable entertainment device in accordance with the present invention;

FIG. 3 is a flow chart illustrating a method to control release of the removable entertainment device in accordance with the present invention;

FIG. 4 is a state transition diagram illustrating a method of passive anti-theft protection implemented by the docking station in accordance with the present invention; and

FIG. 5 is a state transition diagram illustrating a method of passive anti-theft protection implemented by the removable entertainment device in accordance with the present invention.

### DETAILED DESCRIPTION

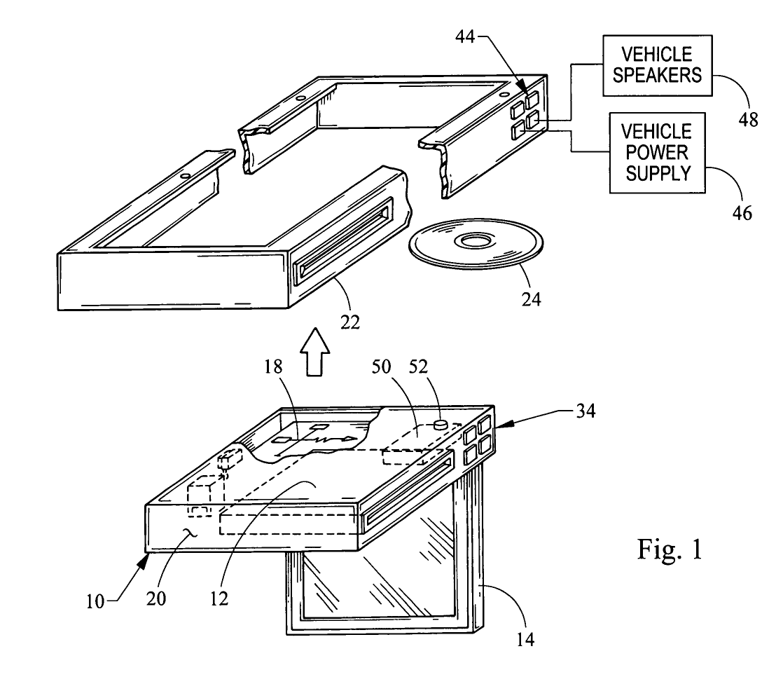

FIG. 1 illustrates a removable entertainment device, generally indicated in the figures at reference numeral 10, in accordance with one embodiment of the present invention. The removable entertainment device 10 includes an information retrieval device 12, a video display screen 14, electronics 18, a housing unit 20, and at least one vehicle docking station 22. The video display screen 14 is preferably pivotally mounted to the housing 20 such that the display screen 14 can be pivoted away from the housing 20 when viewing is desired and toward the housing 20 when storage of the screen 14 is desired. The vehicle docking station 22 releasably receives the housing unit 20.

The information retrieval device 12 is preferably a component that is capable of receiving a removable storage medium 24 and reading entertainment information stored on the medium 24. Particularly preferable, the information retrieval device 12 comprises a component capable of receiving and reading a standard type of storage media. As illustrated in the figure, the information retrieval device 12 preferably comprises a DVD (digital video disk) drive. In this embodiment, the removable storage medium 24 comprises a DVD. Alternatively, the information retrieval device 12 can comprise a compact disk (CD) drive, a CD-ROM drive, a removable or fixed hard drive, a videocassette drive, or any other suitable component. The removable storage medium 24 will of course be appropriate for the type of information retrieval device 12 utilized.

The video display screen 14 comprises the video output device of the removable entertainment device 10. As such, the screen 14 displays images based on information contained on the removable storage medium 24 as read by the information retrieval device 12. The type of video display screen 14 employed will depend on the desired resolution and picture quality. LCD screens, such as those used in portable computers and personal entertainment systems, are suitable.

The electronics 18 are adapted to read the information stored on the removable storage medium 24 and to display an image based on this information onto the video display screen 14. As such, suitable electronics 18 include those typically utilized in the type of information retrieval device 12 employed in the removable entertainment device 10.

The housing unit 20 contains the information retrieval device 12 and the electronics 18. Preferably, the housing unit 20 encases the information retrieval device 12 and electronics 18 while still allowing the information retrieval device 12 to receive a removable storage medium 24 and the terminals of connector 34 to interact with external electrical components. Further, the housing unit 20 preferably mounts the video display screen 14 in a manner that allows the screen 14 to pivot between first and second positions. In the first position, the screen 14 is preferably positioned directly adjacent the housing 20 such that the image cannot be viewed on the screen. In a second position, the screen 14 is preferably positioned substantially perpendicular to the length of the housing 20 such that the image 26 can be optimally viewed. Any suitable structural interaction between the housing 20 and video display screen 14 that achieves this pivotal relationship can be utilized.

The vehicle docking station 22 is able to releasably receive the housing unit 20. The vehicle docking station 22 also preferably contains fasteners for attaching the bracket 22 to the vehicle, such as at the roof or ceiling of the vehicle. In addition, the vehicle docking station 22 preferably defines one or more electrical connectors 44 that are in electrical communication with at least a power supply 46 and, either directly or indirectly, one or more speakers 48 of the vehicle. Preferably, the electrical connector 44 comprises conductive flanges defined by the docking station 22. Alternatively, the electrical connector 44 can comprise terminals of a pigtail connector or another suitable connector passed through an opening defined by the docking station 22.

Preferably, the electrical connector 44 is positioned such that it frictionally engages the terminals of connector 34 as the housing unit 20 is received by the vehicle docking station 22. The electrical connector 44 and connector 34 are in electrical communication with each other, thereby placing the electronics 18 in electrical communication with the power supply 46 and vehicle audio system 48, when the housing unit 20 is fully received by the vehicle docking station 22.

When the housing unit 20 is not seated in the vehicle docking station 22, the removable entertainment device 10 is preferably capable of acting as a self contained entertainment device. Accordingly, the removable entertainment device 10 can further include an internal power supply 50 and an audio output component 52. The internal power supply 50 can comprise any suitable power supply, such as a rechargeable battery. Also, the audio output component 52 can comprise any suitable audio output device, such as a wired ready jack or wireless headphone transmitter, an internal speaker, or a speaker jack.

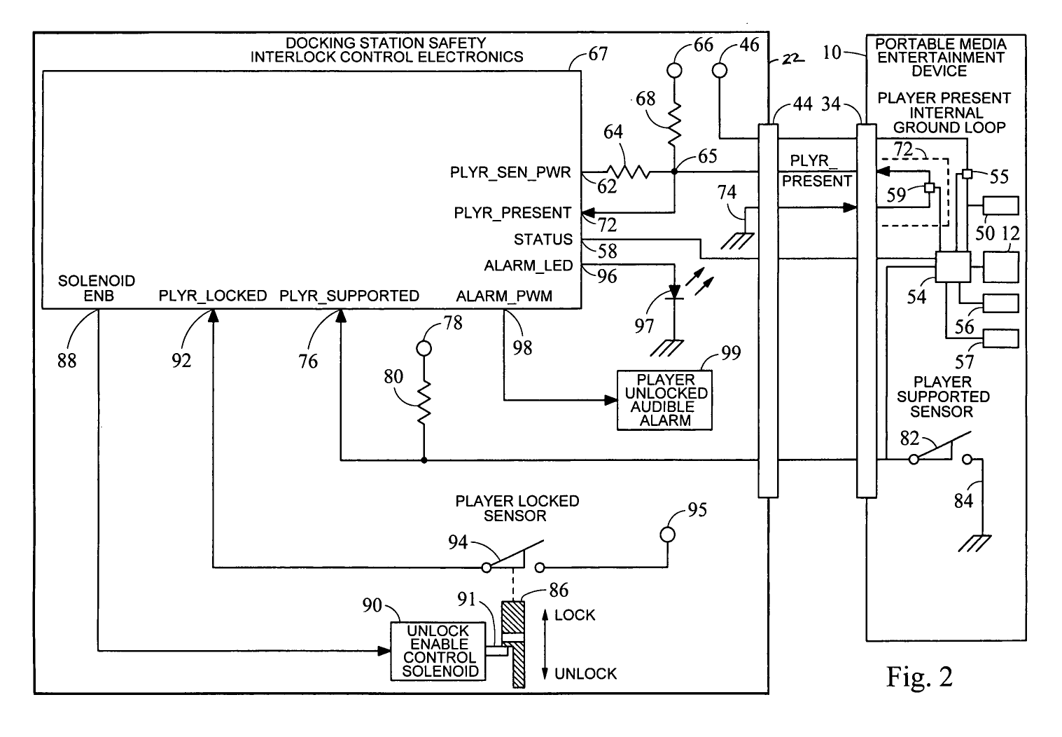

Now referring to FIG. 2, a schematic view of the removable entertainment device 10 and the docking station 22 are provided. The docking station 22 includes a controller 60 that monitors and controls operation of the docking station 22. The controller 60 is in electrical communication with the removable entertainment device 10. More specifically, the controller 60 is in electrical communication with a controller 54 configured to monitor and control operation of the removable entertainment device 10. Controller 60 and controller 54 communicate control information across a status signal 58. The status signal 58 may be communicated over a physical connection or using a wireless communication technology such as an infrared communication link. Accordingly, all of the input or output information from controller 60 may be made available to controller 54 and all of the input or output information of controller 54 may be made available to controller 60 over the status signal 58. Controller 54 is located in the removable entertainment device 10 and is in electrical communication with the information retrieval device 12. The controller 54 may manipulate the information retrieval device 12 to retract or eject media, as well as, access data therefrom.

The removable entertainment device 10 is connected to the docking station 22 through electrical connector 34 and electrical connector 44. Accordingly, the removable entertainment device 10 is connected to a power supply 46 in the docking station 22. The power supply 46 may provide power for operation of the removable entertainment device 10, as well as charging of the internal power supply 50. The power sensor 55 is in electrical communication with the power supply 46 and may provide a signal to the controller 54 when the power supply 46 is disconnected from the removable entertainment device 10. In a similar fashion, a player present sensor 59 is in communication with a player present circuit of the docking station 22 and provides a signal to the controller 54 when the player present circuit is disconnected from the portable media device 10. The removable entertainment device 10 includes a screen closure sensor 56 and a movement sensor 57 in electrical communication with the controller 54.

The controller 60 includes a player power output 62 which is connected to a first end of resistor 64. The other end of resistor 64 is connected to the removable entertainment device 10 through node 65. Node 65 is connected to a power source 66 through a pull up resistor 68. A player present input 70 of the controller 60 is also in communication with node 65. Accordingly, if the removable entertainment device 10 is not connected to the docking station 22, the player present input 70 is pulled high by the power source 66. Alternatively, when the removable entertainment device 10 is present, node 65 is pulled to a reference voltage, such as ground 74 through the removable entertainment device 10. Node 65 is connected to the ground 74 along a ground loop 72 in the removable entertainment device 10 that is accessed through connectors 34 and 44.

In addition, the controller 60 includes a player supported input 76. The player supported input 76 detects whether pressure is being applied to the removable entertainment device 10. If the removable entertainment device 10 is received into the bottom of the docking station 22 as shown in FIG. 1, the removable entertainment device 10 will need to be supported when released by the docking station 22 to prevent dropping of the removable entertainment device 10. Support can be provided by an occupant pushing upward on the removable entertainment device 10 prior to release by the docking station 22. This support may be measured by a pressure sensor 82, such as a pressure sensitive switch interfaced with the removable entertainment device 10. The player supported input 76 is connected to a power source 78 through a pull up resistor 80. The player supported input 76 is also connected to the pressure sensor 82 in the removable entertainment device 10 through connectors 34 and 44. If pressure is applied to the removable entertainment device 10, the pressure sensor 82 connects the player supported input 76 to a reference voltage, such as ground 84. In addition, the pressure sensor 82 is in electrical communication with the controller 54 allowing the information retrieval device 12 to retract the removable storage media 24 based on a signal from the pressure sensor 82.

To control whether the removable entertainment device 10 is latched into the docking station 22, a solenoid enable output 88 is provided. The solenoid enable output 88 controls a solenoid 90, thereby moving a pin 91. The pin 91 is biased to engage a latch 86 preventing movement of the latch 86. The latch 86 engages the removable entertainment device 10 preventing it from being released by the docking station 22. The solenoid enable output 88 is configured to activate the solenoid 90 thereby disengaging the pin 91 and allowing movement of the latch 86 when the removable entertainment device 10 is supported. For example, the controller 60 may check the player supported input 76 to determine if the removable entertainment device 10 is supported prior to allowing movement of the latch 86. Accordingly, the removable entertainment device 10 will not be released from the docking station 22 unless sufficient support is provided to prevent the removable entertainment device 10 from falling. A player locked input 92 is also provided by the controller 60. The player locked input 92 is connected to a player locked sensor 94 such as a switch. The player locked sensor 94 is configured to determine if the latch 86 is in the locked position. If the latch 86 is not in the locked position, the player locked sensor 94 connects a voltage source 96 to the player locked input 92 to inform the controller 60 that the latch 86 has been moved to the unlocked position thereby releasing the removable entertainment device 10 from the docking station 22.

In addition, the controller 60 includes optical alarm output 96 connected to an illumination device such as a LED 97. The controller may activate the optical alarm output 96 causing blinking of the LED 97 based on an error condition perceived by the controller 60. The error condition may include such things as the player locked sensor 94 indicating the latch 86 is in an unlocked position when the player supported input 76 indicates the removable entertainment device 10 is not supported.

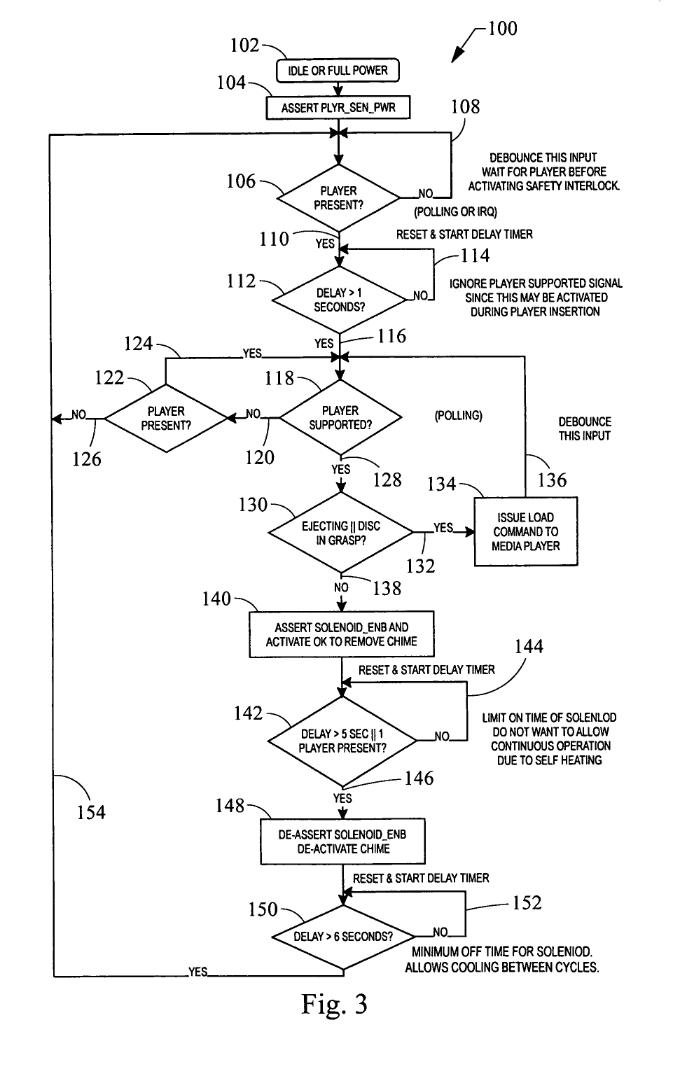

Now referring to FIG. 3, a method 100 for releasing the removable entertainment device 10 from the docking station 22 is provided. In block 102, the controller 60 determines if the vehicle is in idle or full power mode, the player power output 62 is asserted as denoted by block 104. In block 106, the controller 60 determines if the removable entertainment device 10 is present based on the player present input 70. The player present input 70 may be monitored by the controller 60 via a polling routine or through an interrupt driven request. If the player is not present, the logic follows line 108 and loops back to block 106 until the player is present. When the player is present, the logic follows line 110 to block 112. In block 112, the controller 60 determines whether a one second delay has been met. If a one second delay has not been met, the logic follows line 114 back to block 112 until the delay has been met. The controller 60 may provide the capability to configure any of the delays within a range, for example, between one and ten seconds. If the delay is met, the logic flows along line 116 to block 118.

In block 118, the controller 60 determines whether the player is supported via the player supported input 76. If the removable entertainment device 10 is not supported, the logic follows along line 120 and the controller 60 determines if the removable entertainment device 10 is present as denoted by block 122. The controller 60 determines if the removable entertainment device 10 is present based on the player present input 70. If the player is not present, the logic flows along line 126 back to block 106 where the method 100 loops until the removable entertainment device 10 becomes present. If the logic in block 122 determines the removable entertainment device 10 is present, the logic flows along line 124 back to block 118, thereby forming a loop until the removable entertainment device 10 is supported. If the removable entertainment device 10 is supported, the logic flows along line 128 to block 130.

In block 130, the controller 60 determines whether the information retrieval device 12 is currently ejecting or if the removable storage medium 24 is in the slot of the information retrieval device 12. If the information retrieval device 12 is ejecting or the removable storage medium 24 is in the slot, the logic flows along line 132 to block 134. In block 134, a load command is issued to the information retrieval device 12 to retract the removable storage medium 24 into the information retrieval device 12. Thereafter, logic flows along line 136 to block 118. Alternatively, if the information retrieval device 12 is not ejecting and the removable storage medium 24 is not in the slot as determined by block 130, the logic flows along line 138.

In block 140, the controller 60 asserts the solenoid enable output 88 and activates a chime indicating the removable entertainment device 10 is ready to be removed. In block 142, the controller 60 determines if a five second delay has been met or if the removable entertainment device 10 is not present as determined by the player present input 70. If the timed delay has not been met and the removable entertainment device 10 is present, the logic flows along line 144 back to block 142. The delay is to limit the “on time” of the solenoid 90 to reduce heating caused by continuous solenoid operation. If the delay is met or the removable entertainment device 10 is no longer present, the logic flows along line 146 to block 148.

In block 148, the controller 60 de-asserts the solenoid enable output 88 and deactivates the remove chime. In block 150, the controller 60 determines whether a delay time has been met. If the delay time has not been met, the logic flows along 152 back to block 150 until the timed delay has been met. The timed delay is provided to allow cooling of the solenoid between cycles. When the timed delay has been met in block 150, logic flows along line 154 back to block 106 where the method is continued.

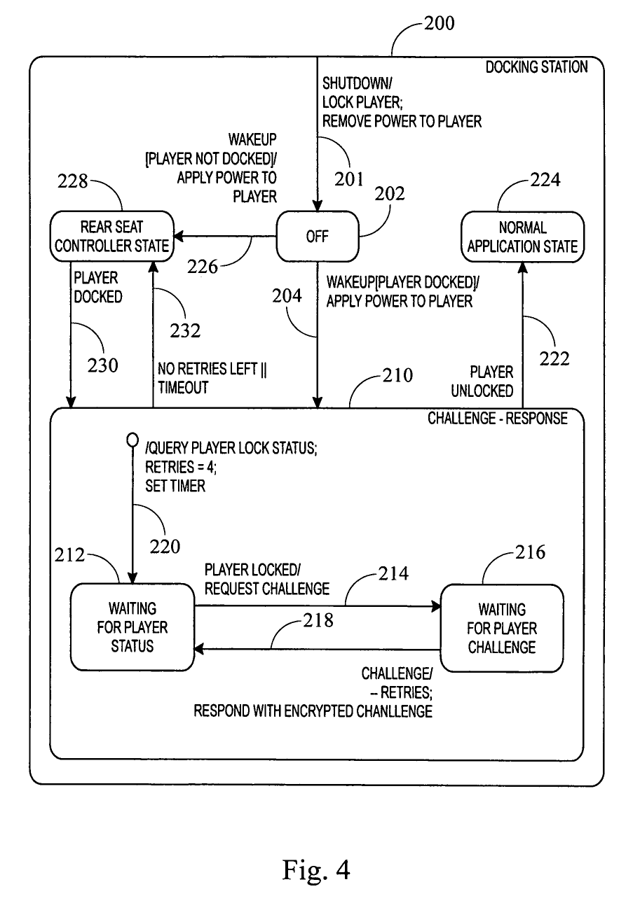

Now referring to FIG. 4, a method 200 is illustrated in a state transition diagram for the docking station anti-theft system. The state transition diagram uses UML notation. Accordingly, transitions are of the form Event [Guard Condition]/Action. Event is interpreted as an occurrence or edge trigger that causes evaluation of the Guard Condition. Guard Condition is a level test. Action is the work performed if the transition is taken (i.e. the Event occurred and the Guard Condition was true). If the condition(s) shown are met (items before the “I”) the Action(s) are performed and the state transitions to the next state as indicated by the arrow. Table 1 is provided below to aid in interpretation of the signals used by the state transition diagram.

TABLE 1
Docking Station Signal Description

| Signal | Type | Description |
|---|---|---|
| Wakeup | Event | The module is awakened from a low or no power state |
| Player Docked | Event | The player has become docked |
| Apply Power to | Action | The docking station applied VBATT to player. |
| Player | | |
| Shutdown | Event | The module is commanded to enter a low or no power state |
| Lock Player | Action | The docking station sends the Lock Enable Message over the |
| | | Status Signal (58) to the player |
| Remove Power to | Action | The docking station removes power from the VBATT of the player |
| Player | | |
| Player Unlocked | Event | The player has responded with status that it is unlocked |
| Player Locked | Event | The player has responded with status that it is locked |
| Query Player | Action | The docking station sends the Lock Status Request message to the |
| Lock Status | | player over the status signal (58) |
| Request | Action | The docking station requests the random seed from the player over |
| Challenge | | the status signal (58) |
| Challenge | Event | The player sends the random seed to the docking station over the |
| | | status signal (58) |
| Response with | Action | The docking station encrypts the random seed using the private key |
| Encrypted | | and sends the encrypted result to the player over the status signal |
| Challenge | | (58) |
| Player not | Guard | A level test to see if the player is currently not docked |
| Docked | Condition | |
| Player Docked | Guard | A level test to see if the player is currently docked |
| | Condition | |

The software lock described ensures that theft or any other form of invalid removal of the removable entertainment device 10 will render the device inoperable.

From any of the states when the docking station 22 is shut down, a signal is sent to the portable entertainment media device 10 to lock the removable entertainment device 10 and remove power, as indicated by line 201. Accordingly, the method 200 to enter the OFF state as denoted by block 202. When the docking station wakes up and the removable entertainment device 10 is docked, the controller 60 applies power to the removable entertainment device 10 as denoted by line 204 and transitions to the challenge response state in block 210.

The challenge response state 210 is initialized as denoted by line 220. During initialization, the player locked status is queried, the number of retries is set to a predetermined number such as four, and the timer is set to a predetermined timeout value. After initialization, the logic enters block 212 waiting for player status. If the removable entertainment device 10 is locked the controller 60 requests a challenge as noted by line 214 thereby switching the method 200 into the waiting for player challenge state as noted by block 216. If a challenge (seed) is provided from the removable entertainment device 10, the docking station 22 responds with an encrypted challenge (key) as noted by line 218 allowing the controller 60 to enter the waiting for player status state as noted by block 212.

If the encrypted challenge is correct, the removable entertainment device 10 is unlocked as denoted by line 222 and the docking station 22 enters a normal application state as denoted by block 224. However, if no retries are left, or the challenge response state reaches a time-out, the method 210 flows along line 232 and enters a rear seat control state as denoted by block 228. In the rear seat controller state, the docking station 22 provides auxiliary controls for accessories other than the removable entertainment device 10, such as radio controls or climate controls.

If the docking station 22 is in the OFF state 202 and the docking station 22 wakes up, however, the removable entertainment device 10 is not docked, the player power is enabled as denoted by line 226. Following line 226, the method 200 directly enters the rear seat controller state in block 228. When the removable entertainment device 10 is docked as denoted by line 230, the docking station 22 enters the challenge response state 210 to verify the removable entertainment device 10 is docked using the seed/key scenario as described above.

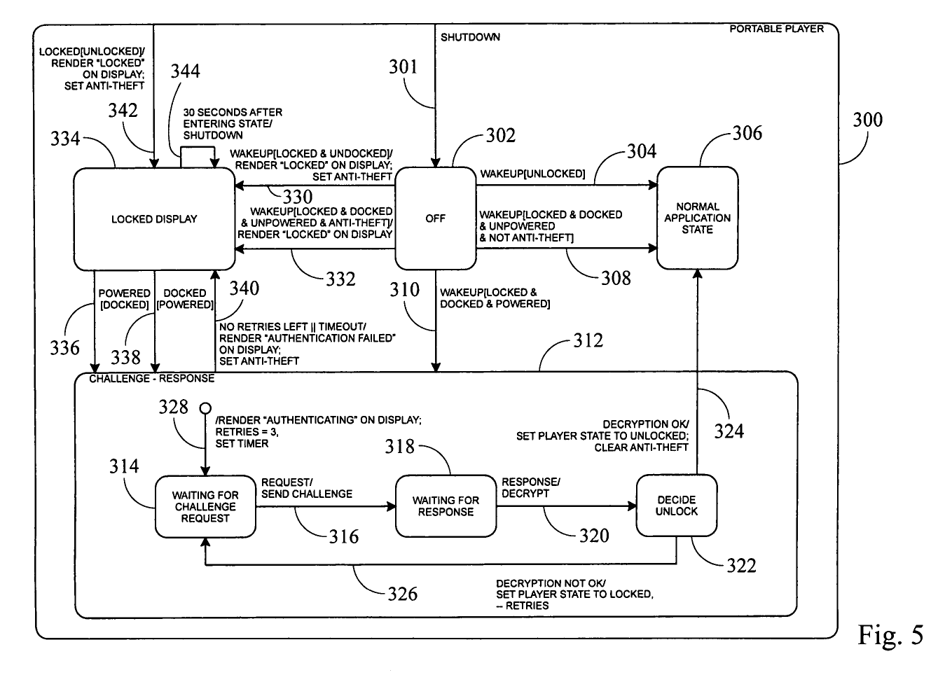

Now referring to FIG. 5, a method 300 is illustrated in a state transition diagram for controlling the removable entertainment device 10. To aid in the interpretation of the signals used in the state transition diagram Table 2 is provided below.

TABLE 2
Player Signal Description

| Signal | Type | Description |
|---|---|---|
| Wakeup | Event | The module is awakened from a low or no power state |
| Locked | Guard | Returns true if the Player is locked |
| | Condition | |
| Docked | Guard | Returns true if the Player is currently installed in the docking station |
| | Condition | |
| Unlocked | Guard | Returns true if the Player is currently not locked |
| | Condition | |
| Undocked | Guard | Returns true if the Player is currently not installed in the docking |
| | Condition | station |
| Powered | Guard | Returns true if power is currently applied to the VBATT and Status |
| | Condition | Signal (58) |
| Unpowered | Guard | Returns true if power is not currently applied to the VBATT and |
| | Condition | Status Signal (58) |
| Anti-theft | Guard | Returns true if the Player is currently locked due to a theft attempt |
| | Condition | |
| Powered | Event | Power has just been applied to VBATT and Status Signal (58) |
| Docked | Event | The Player has just been installed into the docking station |
| Locked | Event | The Player has just been locked |
| Request | Event | The docking station has just sent the request for the random seed |
| | | over the Status Signal (58) |
| Response | Event | The docking station has just sent the encrypted random seed over |
| | | the Status Signal (58) |
| Decryption | Event | The decrypted docking station response matches the original |
| OK | | random seed |
| Send | Action | The Player sends the random seed to the docking station over the |
| Challenge | | Status Signal (58) |
| Decrypt | Action | The Player decrypts the docking station's response using the |
| | | private Key |
| Clear Anti- | Action | Clears the Anti-theft flag |
| Theft | | |
| Lock | Event | The docking station sent the Lock Enable message over the Status |
| Command | | Signal (58) |
| Ready to | Guard | The player is allowed to lock |
| Lock | Condition | |
| Lock Status | Event | The docking station sends the Lock Status Request message to the |
| Request | | player over the Status Signal (58) |
| Send Player | Action | The player sends the Player Locked status message to the docking |
| Locked | | station over the Status Signal (58) |
| Send Player | Action | The players sends the Player Unlocked status message to the |
| Unlocked | | docking station over the Status Signal (58) |
| Shutdown | Event | The player is commanded to enter a low or no power state |
| Shutdown | Action | Issue the Shutdown event |

As denoted by line 301, shut down from any of the other state transitions method 300 into the OFF state as denoted by block 302. When the removable entertainment device 10 wakes up and is unlocked as denoted by line 304, the removable entertainment device 10 transitions the normal application state as denoted by block 306. Similarly, when the removable entertainment device 10 wakes up and is locked, docked, unpowered, and the anti-theft is not active as denoted by line 308, the removable entertainment device 10 also enters the normal application state 306. If the removable entertainment device 10 wakes up and the removable entertainment device 10 is locked, docked, and powered as denoted by line 310, the removable entertainment device 10 enters the challenge response state as denoted by block 312.

The challenge response state is initialized as denoted by line 328. During initialization, an authenticating message is rendered on the display, the number of retries is set to three, and a timer is set. The removable entertainment device 10 enters the waiting for challenge request state as denoted by block 314. A request to send challenge, including a seed, is then provided to the docking station 22 as denoted by line 316. Accordingly, the portable media player enters the waiting for response state as denoted by block 318. A response, including a key, is received and decrypted as denoted by line 320 allowing the removable entertainment device 10 to enter the decide unlock state 322. If the decryption is correct, the removable entertainment device 10 is unlocked, the anti-theft flag is cleared as denoted by line 324 allowing the removable entertainment device 10 to enter the normal application state 306. If the decryption is not correct, the removable entertainment device 10 is set to locked and the number of retires is decremented as denoted by line 326. This causes the removable entertainment device 10 to enter the waiting for challenge request state 314. Accordingly, the request to send challenge may be resent until no retries are left or the challenge response state times out. If no retries are left or the challenge response state times out, an authentication failed message is rendered on the display and the anti-theft flag is set as denoted by line 340. After the anti-theft flag is set, the removable entertainment device 10 enters the lock display state in block 334.

In addition, if the removable entertainment device 10 wakes up in a locked and undocked state, a locked message is rendered on the display and the anti-theft flag is set as denoted by line 330 causing the removable entertainment device 10 to enter the locked display state 334. Similarly, if the removable entertainment device 10 wakes up locked and undocked and unpowered and the anti-theft flag is set, then a locked message is rendered on the display as indicated by line 332. The removable entertainment device 10 again enters the locked display state 334.

While in the locked display state 334, if the removable entertainment device 10 is powered while the portable media entertainment 10 is docked as indicated by line 336, the removable entertainment device 10 enters the challenge response state 312. Similarly, if the removable entertainment device 10 is docked while it is powered, as indicated by line 338, the removable entertainment device 10 also enters the challenge response state 312. As indicated by line 342, if the portable medial entertainment device 10 is locked and undocked, the locked message is rendered on the display and the anti-theft flag is set causing the portable medial entertainment device 10 to enter the locked display stated 334. Further, as noted by line 344, thirty seconds after entering the locked display state 334, the removable entertainment device 10 shuts down which will transition the removable entertainment device to line 301, thereby entering the OFF state 302.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

I/We claim:

1. A system for preventing theft, the system comprising:
a removable entertainment device including a device controller, the removable entertainment device having a locked mode and an unlocked mode, the locked mode having reduced functionality from the unlocked mode;
a docking station configured to receive the removable entertainment device, the docking station including a docking station controller, wherein the device controller and the docking station controller are in electrical communication when the removable entertainment system is received by the docking station;
wherein the removable entertainment device is configured to transition from the locked mode to the unlocked mode when the removable entertainment system is received by the docking station.

2. The system according to claim 1, wherein the device controller is configured to send a challenge message to the docking station controller, and the docking station controller is configured to send a response message to the device controller, the device controller being configured to transition to the unlocked mode based on the response message.

3. The system according to claim 2, wherein the device controller passes a seed to the docking station controller, the docking station controller being configured to perform an algorithm on the seed to create a key and return the key to the device controller.

4. The system according to claim 3, wherein the device controller decodes the key using the algorithm to produce a authentication seed, the device controller being configured to transition to the unlocked state if the authentication seed matches the seed.

5. The system according to claim 2, wherein the device controller is configured to retry the challenge message if a response message is not received within a predefined time period.

6. The system according to claim 5, wherein the controller is configured to stop sending challenge messages after a predefined number of retries.

7. The system according to claim 1, wherein the removable entertainment device enters the locked mode based on the vehicle shutdown.

8. The system according to claim 7, wherein the removable entertainment device enters the locked mode if the removable entertainment device is received in the docking station during vehicle shutdown.

9. The system according to claim 1, wherein the docking station is configured to prevent release of the removable entertainment device when the vehicle is shutdown.

10. The system according to claim 9, wherein the docking station includes a latch configured to releasibly engage the removable entertainment system and the docking station is configured to disable the latch when the vehicle is shutdown.

11. A system for preventing theft, the system comprising:
a removable entertainment device including a device controller, the removable entertainment device having a locked mode and an unlocked mode, the locked mode having reduced functionality from the unlocked mode;
a docking station configured to receive the removable entertainment device, the docking station including a docking station controller, wherein the device controller and the docking station controller are in electrical communication when the removable entertainment system is received by the docking station;
the removable entertainment device is configured to transition from the locked mode to the unlocked mode when the removable entertainment system is received by the docking station;
the removable entertainment device enters the locked mode based on the vehicle shutdown; and
the docking station is configured to prevent release of the removable entertainment device when the vehicle is shutdown.

12. The system according to claim 11, wherein the device controller is configured to send a challenge message to the docking station controller, and the docking station controller is configured to send a response message to the device controller, the device controller being configured to transition to the unlocked mode based on the response message.

13. The system according to claim 12, wherein the device controller passes a seed to the docking station controller, the docking station controller being configured to perform an algorithm on the seed to create a key and return the key to the device controller.

14. The system according to claim 13, wherein the device controller decodes the key using the algorithm to produce a authentication seed, the device controller being configured to transition to the unlocked state if the authentication seed matches the seed.

15. The system according to claim 12, wherein the device controller is configured to retry the challenge message if a response message is not received within a predefined time period.

16. The system according to claim 15, wherein the controller is configured to stop sending challenge messages after a predefined number of retries.

17. The system according to claim 16, wherein the removable entertainment device enters the locked mode if the removable entertainment device is received in the docking station during vehicle shutdown.

18. The system according to claim 17, wherein the docking station includes a latch configured to releasibly engage the removable entertainment system and the docking station is configured to disable the latch when the vehicle is shutdown.
